(19) United States
(12) Patent Application Publication
(10) Pub. No.: US 2026/0194026 A1
(43) Pub. Date: Jul. 9, 2026

(54) PISTON AND ENGINE

(71) Applicants: WEICHAI POWER CO., LTD., Shandong (CN); BAUDOUIN (WEIFANG) POWER CO., LTD., Shandong (CN)

(72) Inventors: Peiji ZHAO, Shandong (CN); Hongyang ZHANG, Shandong (CN)

(21) Appl. No.: 18/863,803

(22) PCT Filed: May 9, 2023
(86) PCT No.: PCT/CN2023/092865

§ 371 Date: Nov. 7, 2024

(30) Foreign Application Priority Data
May 10, 2022 (CN) 202210505523.6

(51) Int. Cl. F02F 3/22

(52) U.S. Cl. CPC F02F 3/22

(57) ABSTRACT

In a piston, a first annular protrusion protrudes from the inner annular wall of the internal oil cooling channel, a guide contour is provided on the upper part of the first annular protrusion, the guide contour is disposed obliquely downward, a second annular protrusion protrudes from the outer annular wall of the internal oil cooling channel, the second annular protrusion is located below the first annular protrusion, the first annular protrusion is located on the inner annular wall of the internal oil cooling channel and below the throat, the second annular protrusion is located on the outer annular wall of the internal oil cooling channel, and the first annular protrusion is provided at a position corresponding to the first annular groove.

This application claims priority to Chinese Patent Application No. 202210505523.6 filed with the China National Intellectual Property Administration (CNIPA) on May 10, 2022, the disclosure of which is incorporated herein by reference in its entirety.

### TECHNICAL FIELD

The present application relates to the technical field of engines, for example, a piston and an engine.

### BACKGROUND

A piston is an important component in an engine. The piston is located in a cylinder of the engine, and a combustion chamber is located at the end of the piston. The piston is pushed to reciprocate in the cylinder of the engine by continuously burning fuel to do work. The end of the piston facing away from the combustion chamber is connected to a motor oil chamber of the engine. During the operation of the engine, the motor oil lubricates and cools the piston.

In actual use, the temperature of the end of the piston facing the combustion chamber is higher, and the piston is easy to fail due to high temperature after used for a long time, especially at a piston throat and a first annular groove. If these two places cannot be cooled in time, the piston is easily damaged at the throat and the first annular groove and fails after used for a long time, reducing the service life of the engine.

In the utility model patent with the publication number CN210139037U, a piston is introduced, in which an internal oil cooling channel is provided. An upper cavity of the internal oil cooling channel is aligned with the position of the piston throat. The internal oil cooling channel of the piston is formed by using the salt core shape in this technology. The formed internal oil cooling channel is an annular protrusion similar to a triangular structure. During use, the motor oil is sprayed from an oil inlet into the internal oil cooling channel. The motor oil changes the flow direction after blocked and guided by the annular protrusion and eventually forms a vortex in the upper cavity of the internal oil cooling channel so that the residence time of the motor oil in the upper cavity of the internal oil cooling channel can be increased, thereby improving the cooling effect on the piston throat. However, for the cooling of the first annular groove, the motor oil at an oil outlet quickly passes through the outer annular wall of the internal oil cooling channel to cool the first annular groove at the oil outlet. Since the upper cavity of the internal oil cooling channel is located above the first annular groove, after the motor oil forms a vortex in the upper cavity, the amount of motor oil flowing through the outer annular wall of the internal oil cooling channel close to the position of the first annular groove is smaller, resulting in a limited cooling effect on the first annular groove.

In the utility model patent with the publication number CN212337476U, a steel piston is introduced. From the attached drawings of the patent, it can be seen that the internal oil cooling channel is also provided in the piston, two annular protrusions are provided in the internal oil cooling channel and located on two sidewalls of the internal oil cooling channel, respectively, the two annular protrusions are staggered, and the two annular protrusions are W-shaped. In the structural design of the piston, the main effect of this structural design is to enhance the oscillation and splashing effect of the motor oil after the motor oil is sprayed into the internal oil cooling channel so that the range of oscillation and splashing of the motor oil is wider, thereby increasing the area of the internal oil cooling channel covered by the motor oil. The specific process is described below. The motor oil is sprayed obliquely from the oil inlet into the internal oil cooling channel, and the motor oil is directly sprayed onto the outer surface of the lower annular protrusion. Due to the specific shape of the lower annular protrusion, the splashing effect of the motor oil can be improved. Part of the motor oil after splashing continues splashing to the upper annular protrusion. Similarly, part of the motor oil after splashing to the upper annular protrusion continues splashing to the lower annular protrusion. This reciprocating process forms an oscillation effect in the internal oil cooling channel so that the coverage of the motor oil in the internal oil cooling channel can be increased, and finally, the motor oil flows out from the oil outlet of the internal oil cooling channel. The internal oil cooling channel is configured in this manner. A vortex or a circulation cannot be formed in the internal oil cooling channel, and this manner is more inclined to improve the oscillation effect of the motor oil in the internal oil cooling channel but cannot focus on cooling the piston throat and the first annular groove, resulting in a limited cooling effect on the throat and the first annular groove.

The disadvantage of the preceding piston structure is that when the motor oil flows in the internal oil cooling channel, it is difficult to achieve a better cooling effect on the throat and the first annular groove at the same time.

### SUMMARY

The present application provides a piston and an engine so that two important positions, that is, a throat and a first annular groove in a piston structure can be better cooled at the same time.

The present application provides a piston. A throat is provided at a top of the piston, a first annular groove is provided on an outer circumferential surface of the piston, an annular internal oil cooling channel is provided between the throat and the first annular groove, a first annular protrusion protrudes from an inner annular wall of the internal oil cooling channel, a guide contour is provided on a upper part of the first annular protrusion, the guide contour is disposed obliquely downward from the inner annular wall of the internal oil cooling channel to an outer annular wall of the internal oil cooling channel, a second annular protrusion protrudes from the outer annular wall of the internal oil cooling channel, the second annular protrusion is located below the first annular protrusion, the first annular protrusion is located on the inner annular wall of the internal oil cooling channel and below the throat, the second annular protrusion is located on the outer annular wall of the internal oil cooling channel, and the first annular protrusion is provided at a position corresponding to the first annular groove.

The present application further provides an engine having the preceding piston.

### BRIEF DESCRIPTION OF DRAWINGS

FIG. 1 is a sectional view of a piston in the present application from a top view perspective.

FIG. 2 is a sectional view taken along A-A in FIG. 1.

FIG. 3 is a sectional view taken along B-B in FIG. 1.

FIG. 4 is a partial enlarged view of part A in FIG. 3.

FIG. 5 illustrates the flow direction of motor oil at an oil inlet in an internal oil cooling channel of the present application.

### REFERENCE LIST

1 throat
2 first annular groove
3 internal oil cooling channel
31 oil inlet
32 oil outlet
33 upper cavity
34 first portion
35 second portion
4 first annular protrusion
41 guide contour
42 flow guide contour
5 second annular protrusion
51 notch
52 cut-off contour

### DETAILED DESCRIPTION

The present application is further described in detail hereinafter in conjunction with the drawings and embodiments. It is to be understood that the examples described herein are merely intended to illustrate the present application. Additionally, it is to be noted that for ease of description, only part, not all, of structures related to the present application are illustrated in the drawings.

In the description of the present application, terms “joined”, “connected”, and “fixed” are to be understood in a broad sense unless otherwise expressly specified. For example, the term “connected” may refer to “fixedly connected”, “detachably connected”, or “integrated”, may refer to “mechanically connected” or “electrically connected”, or may refer to “connected directly”, “connected indirectly through an intermediary”, or “connected inside two elements” or “an interaction relation between two elements”. For those of ordinary skill in the art, specific meanings of the preceding terms in the present application may be understood based on specific situations.

In the present application, unless otherwise expressly specified, when a first feature is described as “on” or “below” a second feature, the first feature and the second feature may be in direct contact or be in contact via another feature between the two features instead of being in direct contact. Moreover, when the first feature is described as “on”, “above”, or “over” the second feature, the first feature is right on, above, or over the second feature, the first feature is obliquely on, above, or over the second feature, or the first feature is simply at a higher level than the second feature. When the first feature is described as “under”, “below”, or “underneath” the second feature, the first feature is right under, below, or underneath the second feature, the first feature is obliquely under, below, or underneath the second feature, or the first feature is simply at a lower level than the second feature.

In the description of this embodiment, orientations or position relations indicated by terms such as “above”, “below”, “left”, and “right” are based on the drawings. These orientations or position relations are intended only to facilitate description and simplify operations and not to indicate or imply that a device or element referred to must have such particular orientations or must be configured or operated in such particular orientations. In addition, the terms “first” and “second” are only used for distinguishing between descriptions and have no special meanings.

In the related art, an internal oil cooling channel is provided in a piston. An upper cavity of the internal oil cooling channel is aligned with the position of the piston throat. The internal oil cooling channel of the piston is formed by using the salt core shape in this technology. The formed internal oil cooling channel is an annular protrusion similar to a triangular structure. During use, the motor oil is sprayed from an oil inlet into the internal oil cooling channel. The motor oil changes the flow direction after blocked and guided by the annular protrusion and eventually forms a vortex in the upper cavity of the internal oil cooling channel so that the residence time of the motor oil in the upper cavity of the internal oil cooling channel can be increased, thereby improving the cooling effect on the piston throat. However, for the cooling of the first annular groove, the motor oil at an oil outlet quickly passes through the outer annular wall of the internal oil cooling channel to cool the first annular groove at the oil outlet. Since the upper cavity of the internal oil cooling channel is located above the first annular groove, after the motor oil forms a vortex in the upper cavity, the amount of motor oil flowing through the outer annular wall of the internal oil cooling channel close to the position of the first annular groove is smaller, resulting in a limited cooling effect on the first annular groove.

To solve the preceding problem, the present application adopts a piston with a specific structure described below.

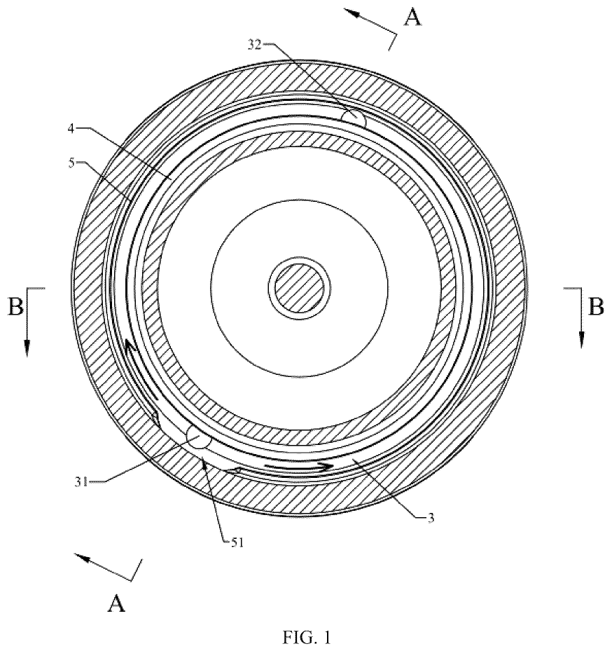

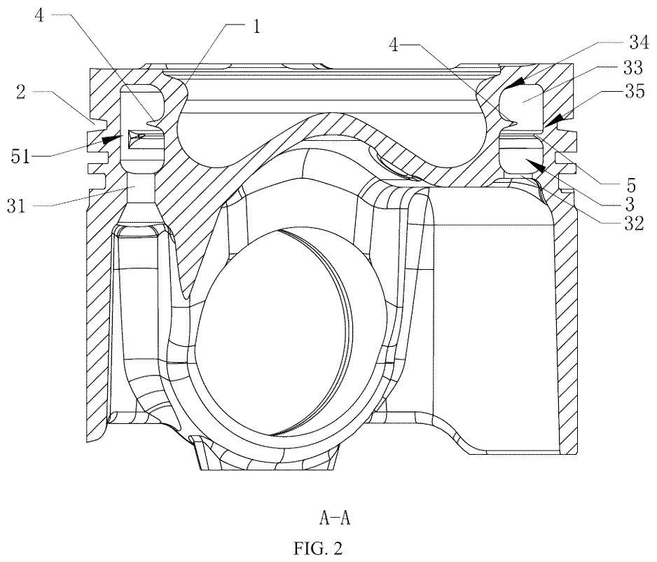

As shown in FIGS. 1 and 2, a throat 1 is provided at the top of the piston, a first annular groove 2, a second annular groove, and a third annular groove are provided on the outer circumferential surface of the piston, and the second annular groove and the third annular groove are located below the first annular groove 2. An annular internal oil cooling channel 3 is provided in the piston and located between the throat 1 and the first annular groove 2. An oil inlet 31 and an oil outlet 32 are provided below the internal oil cooling channel 3. The motor oil is sprayed into the internal oil cooling channel 3 through the oil inlet 31. The motor oil flows in the internal oil cooling channel 3 to cool the piston, especially the throat 1 and the first annular groove 2, and then the motor oil flows out from the oil outlet 32. Generally, the oil inlet 31 and the oil outlet 32 are spaced apart by 180°, the bottom of the internal oil cooling channel 3 is disposed obliquely, the oil inlet 31 is disposed at the highest point of the bottom of the internal oil cooling channel 3, and the oil outlet 32 is disposed at the lowest point of the internal oil cooling channel 3 so that the motor oil in the internal oil cooling channel 3 can flow out from the oil outlet 32.

In this embodiment, the oil inlet 31 is configured to spray the motor oil upward. In other embodiments, the oil inlet 31 may be configured to spray the motor oil obliquely, and the spraying direction may be adjusted according to design requirements.

As shown in FIG. 2, for the convenience of the description below, the part of the internal oil cooling channel 3 closest to the throat 1 is referred to as a first portion 34, and the part of the internal oil cooling channel 3 closest to the first annular groove 2 is referred to as a second portion 35.

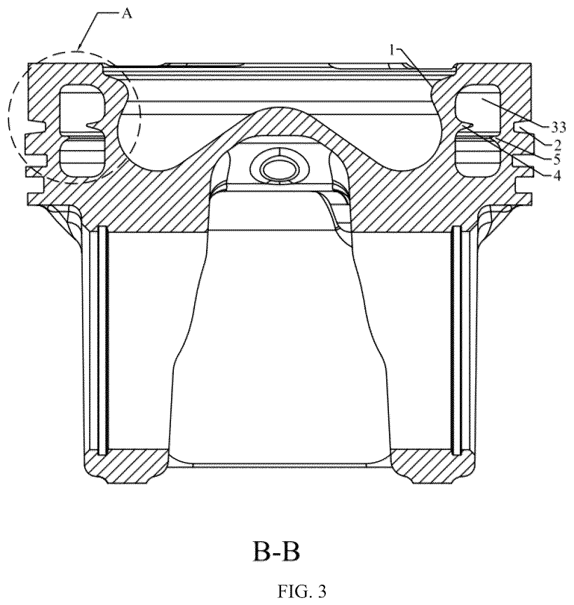

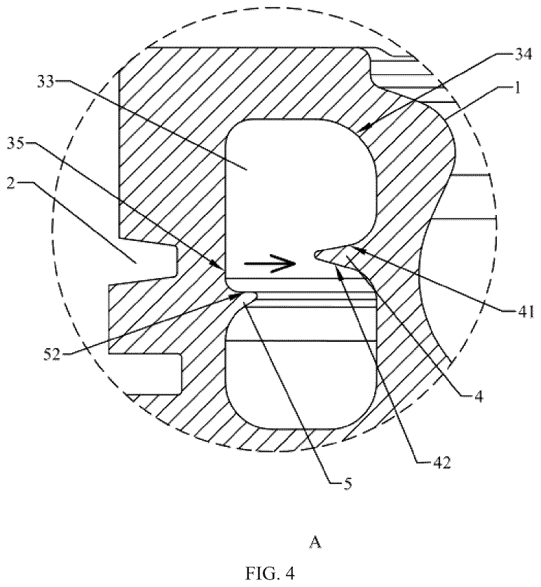

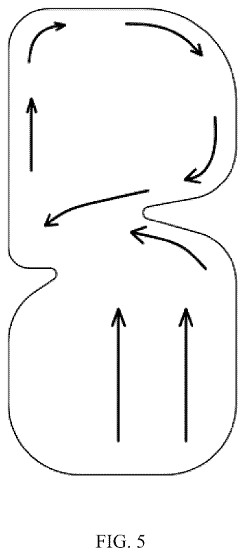

As shown in FIGS. 3 and 4, a first annular protrusion 4 and a second annular protrusion 5 protrude from the annular walls of the internal oil cooling channel 3, the second annular protrusion 5 is located below the first annular protrusion 4, the first annular protrusion 4 is located on the inner annular wall of the internal oil cooling channel 3 and below the throat 1, the second annular protrusion 5 is located on the outer annular wall of the internal oil cooling channel 3, and the first annular protrusion 4 is provided at a position corresponding to the first annular groove 2. In an embodiment, the position of the first annular protrusion 4 may be configured to be higher than the position of the first annular groove 2. For example, the position of the first annular protrusion 4 may be 5 mm higher than the position of the first annular groove 2. Other heights may be set according to actual conditions. A guide contour 41 is provided on the upper part of the first annular protrusion 4, the guide contour 41 is disposed obliquely downward from the inner annular wall of the internal oil cooling channel 3 to the outer annular wall of the internal oil cooling channel 3, and the intersection of the tangent at the end of the guide contour 41 and the outer annular wall of the internal oil cooling channel 3 is located above the second annular protrusion 5. The part of the internal oil cooling channel 3 above the first annular protrusion 4 is referred to as an upper cavity 33. The motor oil is sprayed into the internal oil cooling channel 3 from the oil inlet 31, and the motor oil is sprayed into the upper cavity 33. After blocked and guided by the upper cavity 33, the motor oil flows along the contour of the upper cavity 33 and flows to the guide contour 41. At this time, the motor oil forms a vortex in the upper cavity 33. The vortex flow direction is shown in FIG. 5 in which the motor oil flows in the upper cavity 33, thereby increasing the amount of motor oil flowing through the first portion 34 and improving the cooling effect of the motor oil on the throat 1. The motor oil flowing obliquely downward along the guide contour 41 flows to and impacts the top of the second annular protrusion 5. After blocked by the second annular protrusion 5, the motor oil quickly diffuses along the second annular protrusion 5 and the outer annular wall of the internal oil cooling channel 3 to form a circulation. The direction of the circulation is indicated by the arrows in FIGS. 1 and 4. The motor oil flows along the circumferential surface of the internal oil cooling channel 3 in two directions from the oil inlet 31 to the oil outlet 32, thereby increasing the amount of motor oil flowing through the second portion 35 and improving the cooling effect of the motor oil on the first annular groove 2. In this manner, two important positions, that is, the throat 1 and the first annular groove 2 in the piston structure can be better cooled at the same time.

Further, after the motor oil flowing obliquely downward along the guide contour 41 impacts the top of the second annular protrusion 5, part of the motor oil continues forming a vortex in the upper cavity 33 after blocked by the outer annular wall of the internal oil cooling channel 3, and the vortex in the internal oil cooling channel 3 gradually diffuses and decays in the direction from the oil inlet 31 to the oil outlet 32. However, due to a relatively high impact speed of the motor oil, the vortex can continue diffusing to the top of the oil outlet 32 to cool the throat 1.

To improve the vortex effect in the upper cavity 33, optionally, as shown in FIG. 4, a flow guide contour 42 is provided on the lower part of the first annular protrusion 4, and the flow guide contour 42 is disposed obliquely upward from the inner annular wall of the internal oil cooling channel 3 to the outer annular wall of the internal oil cooling channel 3. At this time, in conjunction with FIG. 5, after the motor oil is sprayed in from the oil inlet 31, part of the motor oil impacts the flow guide contour 42. After blocked and guided by the flow guide contour 42, this part of the motor oil can be guided to flow to the outer annular wall of the upper cavity 33, and then this part of the motor oil flows along the contour of the upper cavity 33, thereby improving the vortex effect formed in the upper cavity 33. In addition, after the motor oil impacts the flow guide contour 42, due to a conical or quasi-conical diffusion surface of the flow guide contour 42, this part of the motor oil can diffuse, thereby improving the distribution uniformity of the motor oil in the internal oil cooling channel 3 and expanding the range of the vortex formed by the motor oil in the upper cavity 33.

As shown in FIG. 4, the upper contour of the second annular protrusion 5 is a cut-off contour 52. Optionally, the cut-off contour 52 is a plane or a concave arc surface. Optionally, in this embodiment, the cut-off contour 52 is a plane perpendicular to a piston axis. In this case, no excess motor oil flowing slowly remains above the cut-off contour 52. After the motor oil impacts the cut-off contour 52, the motor oil is less blocked by the remaining motor oil above the cut-off contour 52. Therefore, the circulation speed of the motor oil above the cut-off contour 52 can be increased, thereby improving the cooling effect on the first annular groove 2. In other embodiments, the cut-off contour 52 may be in other shapes as long as the cut-off contour 52 can cut off the flow of the motor oil to form a circulation.

In addition, when the cut-off contour 52 is flush with the bottom of the first annular groove 2, the motor oil circulation formed above the cut-off contour 52 just flows through the second portion 35. In this case, the cooling effect on the first annular groove 2 is optimal.

Of course, in other aspects, the shapes of the first annular protrusion 4 and the second annular protrusion 5 and the positional relationship between the first annular protrusion 4 and the second annular protrusion 5 are closely related to the intensity of the vortex formed in the upper cavity 33 and the intensity of the circulation above the second annular protrusion 5. The included angle between the guide contour 41 and the flow guide contour 42 is 15° to 40° and may be optionally 26°. The protrusion lengths of the first annular protrusion 4 and the second annular protrusion 5 along the radial direction of the piston are each 3 mm to 4 mm, the height difference between the first annular protrusion 4 and the second annular protrusion 5 in the vertical direction is 8 mm to 9 mm, and the lateral spacing between the first annular protrusion 4 and the second annular protrusion 5 is 9 mm to 11 mm and may be optionally 10 mm. As shown in FIG. 4, the B-B sectional view is used as an example. The height difference between the first annular protrusion 4 and the second annular protrusion 5 in the vertical direction may be understood as the distance between two projections of the first annular protrusion 4 and the second annular protrusion 5 on the outer circumferential surface of the piston; and the lateral spacing between the first annular protrusion 4 and the second annular protrusion 5 may be understood as the distance between two projections of the first annular protrusion 4 and the second annular protrusion 5 on the top of the piston.

Optionally, as shown in FIGS. 1 and 2, the second annular protrusion 5 has a notch 51, and the oil inlet 31 is located below the notch 51. In this case, after the motor oil is sprayed from the oil inlet 31 into the internal oil cooling channel 3, the motor oil directly sprayed from the oil inlet 31 is not blocked by the second annular protrusion 5, and the motor oil diffused after blocked and guided by the first annular protrusion 4 is blocked by the second annular protrusion 5, thereby forming a circulation above the second annular protrusion 5. At the notch 51, the motor oil flow rate of the outer annular wall of the internal oil cooling channel 3 is large so that the cooling effect of the first annular groove 2 at this position is better.

Optionally, the first annular protrusion 4 is provided in a full ring in the internal oil cooling channel 3, that is, the central angle of the first annular protrusion 4 is 360°, and the central angle of the second annular protrusion 5 is 315° to 345° and may be 330°.

This embodiment further introduces an engine having the preceding piston. During the assembly process of the engine, generally, the fuel injector of the engine directly injects fuel to the throat 1 above the oil inlet 31, that is, the fuel burns at the throat 1 above the oil inlet 31, where the temperature of the throat 1 is the highest, while the cooling effect of the internal oil cooling channel 3 at the oil inlet 31 is the best, thereby maximizing the cooling efficiency.

1. A piston, comprising a throat, a first annular groove, an internal oil cooling channel, a first annular protrusion, and a second annular protrusion;
wherein the throat is provided at a top of the piston, the first annular groove is provided on an outer circumferential surface of the piston, the internal oil cooling channel is annular and provided between the throat and the first annular groove, the first annular protrusion protrudes from an inner annular wall of the internal oil cooling channel, a guide contour is provided on a upper part of the first annular protrusion, the guide contour is disposed obliquely downward from the inner annular wall of the internal oil cooling channel to an outer annular wall of the internal oil cooling channel, the second annular protrusion protrudes from the outer annular wall of the internal oil cooling channel, the second annular protrusion is located below the first annular protrusion, the first annular protrusion is located on the inner annular wall of the internal oil cooling channel and below the throat, the second annular protrusion is located on the outer annular wall of the internal oil cooling channel, and the first annular protrusion is provided at a position corresponding to the first annular groove.

2. The piston of claim 1, wherein an upper contour of the second annular protrusion is a cut-off contour, and the cut-off contour is flush with a groove bottom of the first annular groove.

3. The piston of claim 2, wherein the cut-off contour a plane or a concave arc surface.

4. The piston of claim 1, wherein a bottom of the internal oil cooling channel is provided with an oil inlet in communication with the internal oil cooling channel, the second annular protrusion has a notch, and the oil inlet is located below the notch.

5. The piston of claim 4, wherein a central angle of the second annular protrusion is 315° to 345°.

6. The piston of claim 1, wherein a central angle of the first annular protrusion is 360°.

7. The piston of claim 1, wherein a flow guide contour is provided on a lower part of the first annular protrusion and the flow guide contour is disposed obliquely upward from the inner annular wall of the internal oil cooling channel to the outer annular wall of the internal oil cooling channel.

8. The piston of claim 7, wherein an included angle between the guide contour and the flow guide contour is 15° to 40°.

9. The piston of claim 1, wherein protrusion lengths of the first annular protrusion and the second annular protrusion are each 3 mm to 4 mm, a height difference between the first annular protrusion and the second annular protrusion in a vertical direction is 8 mm to 9 mm, and a lateral spacing between the first annular protrusion and the second annular protrusion is 9 mm to 11 mm.

10. An engine, comprising the piston of claim 1, and a cylinder; wherein the piston is located in the cylinder.

11. The engine of claim 10, wherein an upper contour of the second annular protrusion is a cut-off contour, and the cut-off contour is flush with a groove bottom of the first annular groove.

12. The engine of claim 11, wherein the cut-off contour is a plane or a concave arc surface.

13. The engine of claim 10, wherein a bottom of the internal oil cooling channel is provided with an oil inlet in communication with the internal oil cooling channel, the second annular protrusion has a notch, and the oil inlet is located below the notch.

14. The engine of claim 13, wherein a central angle of the second annular protrusion is 315° to 345°.

15. The engine of claim 10, wherein a central angle of the first annular protrusion is 360°.

16. The engine of claim 10, wherein a flow guide contour is provided on a lower part of the first annular protrusion, and the flow guide contour is disposed obliquely upward from the inner annular wall of the internal oil cooling channel to the outer annular wall of the internal oil cooling channel.

17. The engine of claim 16, wherein an included angle between the guide contour and the flow guide contour is 15° to 40°.

18. The engine of claim 10, wherein protrusion lengths of the first annular protrusion and the second annular protrusion are each 3 mm to 4 mm, a height difference between the first annular protrusion and the second annular protrusion in a vertical direction is 8 mm to 9 mm, and a lateral spacing between the first annular protrusion and the second annular protrusion is 9 mm to 11 mm.
